(19) United States
(12) Patent Application Publication
(10) Pub. No.: US 2012/0043759 A1
(43) Pub. Date: Feb. 23, 2012

(54) MULTIPLE CABINETS

(75) Inventor: Mikael Bjork, Karlstad (SE)

(73) Assignee: GE WIND ENERGY (NORWAY) AS, Oslo (NO)

(21) Appl. No.: 13/260,502

(22) PCT Filed: Mar. 23, 2010
(86) PCT No.: PCT/EP2010/053791

§ 371 Date: Sep. 27, 2011

(30) Foreign Application Priority Data
Mar. 25, 2009 (SE) 0950190-9

(51) Int. Cl. H02P 9/04

(52) U.S. Cl. 290/44

(57) ABSTRACT

An electric power generating device comprising a wind power plant 1 with a rotatably turbine shaft 2, a generator 3 connected to a power grid 5, means for rotating the turbine shaft within the generator thus generating AC electrical power, a plurality of frequency converters 4 for converting the frequency of the AC electrical power to the frequency of the power grid, wherein the plurality of frequency converts are electrically connected in parallel in between the generator and the power grid wherein the power generating device further comprises means 48 for registering the amount of power generated in the generator, and means 10 for registering data in the form of the temperature and utilization of each frequency converter respectively, and means for using the registrated data for automatically bringing each of the frequency converters online sequentially and/or means for automatically alternating the order in which the frequency converters are brought online.

The present invention refers to an electric power generating device comprising a wind power plant with a rotatably turbine shaft, a generator connected to a power grid, means for rotating the turbine shaft within the generator thus generating AC electrical power, a plurality of frequency converters for converting the frequency of the AC electrical power to the frequency of the power grid, wherein the plurality of frequency converts are electrically connected in parallel in between the generator and the power grid.

Frequency transforming units are utilized for converting a first input frequency to a second output frequency in situations the output frequency needs to be configurated e.g. with an electricity supplying network, normally of 50 Hz or 60 Hz. In particular, such a function is required when operating variable speed turbines, such as a wind energy turbine, where the input frequency is unpredictable and will depend on the strength of the wind, meaning the speed of the rotor will increase as the wind strengthens. By coupling the rotor windings of the wind turbine generator via a frequency converter to the grid, it is possible to transform the frequency of the power generated by the generator to the frequency of the grid.

Systems where frequency converters are applied in wind power plants are described in US2007/0273155 A1, WO2005/114830 A1 and in U.S. Pat. No. 7,042,110 B2.

US2007/0273155 A1 presents a method for controlling a frequency converter device of a wind power plant, which frequency converter excites the rotor winding which is then connected to the power distribution grid. As is generally known the frequency converter includes a generator-side power converter (AC/DC converter or rectifier) connected to the rotor winding, and a grid-side power converter (DC/AC converter or inverter) connected to the power distribution grid. The rectifier and inverter will together constitute a cabinet. A problem with a system as described in US2007/0273155 A1 is that when the cabinet breaks and/or requires support, the entire turbine needs to shut down until the cabinet has retained its proper function.

These circumstances may lead to substantial energy losses connected to maintenance of the frequency converter equipment, especially if the wind turbine needs to be put to rest when the winds are favorable.

Another common problem related to frequency converters is the occurrence of no-load losses during unfavorable winds. This is due to that the optimal efficiency of a frequency converter is dimensioned to a maximum speed of the wind turbine rotor leading to no-load losses during weak winds and low rotations. (The frequency converter will “try” to convert frequency despite insufficient power leading to the no-lead losses.) Such losses are particularly disadvantageous at low winds since, during those circumstances, the power generated by the turbine is limited as it is, meaning a further loss of energy will correspond to a significant reduction of output power.

U.S. Pat. No. 7,042,110 B2 presents a system with wind turbine drive train with a turbine shaft, a gearbox and a set of four permanent magnet generators, which generators may be individually brought online to generate electric power. Each generator is further connected to a corresponding frequency converter which adapts the frequency of the current from the respective generator to the frequency of the power grid. The system will lead to an improved system efficiency due to the fact that the number of generators in use can be varied depending on the power which is generated by the wind turbine. However, this type of system will lead to a large amount of components which will need frequent maintenance, and, moreover, the arrangement is not suitable for large direct driven generators where the size of the equipment impedes the use of multiple generators, as suggested in U.S. Pat. No. 7,042,110 B2.

Document WO2005/114830 A1 discloses a frequency converter device for a wind energy park which aims to be of a simple and robust construction, thus aiming to reduce the complexity of the system. In particular, WO2005/114830 A1 suggests the use of at least two such frequency converters which will operate simultaneously. In operational mode, a frequency converter will obtain an elevated temperature due to electrical activity therein. This is generally a problem systems such as presented in WO2005/114830 A1, U.S. Pat. No. 7,042,110 B2 and US2007/0273155 since frequency converters have a reduced efficiency at elevated temperatures which, in its turn, decreases the power supply from the wind turbine.

It is an object of the present invention to provide a method and an arrangement for solving, or at least for reducing the above mentioned problems. This is achieved by a method and an arrangement for generating electric power including the use of a wind power plant, which wind power plant comprises a rotatable turbine shaft which extends into a generator which is connected to a power grid, the wind power plant further comprising a plurality of frequency converters for converting the frequency of AC electrical power generated by the generator to the frequency of the power grid. The plurality of frequency converters are electrically connected in parallel in between the generator and the power grid. The generator, the plurality of frequency converters and the power grid may be referred to as an electrical system of the wind power plant. Further, the wind power plant comprises control means for registering whether each of the frequency converters functions properly and means for registering data in the form of the temperature and utilization of each frequency converter respectively.

It is understood that by a “proper function” means that a frequency converter is operable and does not require any reparations or other actions that demands disconnection of the unit from the electrical system. Any frequency converter that does not work properly, e.g. is broken, is referred to as dysfunctional.

Moreover the wind power plant comprises control means for using the registered data for automatically disconnecting and replacing any dysfunctional frequency converter, alternating the use of the frequency converters respectively, bringing each of the frequency converters online sequentially and/or means for automatically alternating the order in which the frequency converters are brought online. A frequency converter is brought online by being connected to the electrical system and, equally, a unit is brought offline by being disconnected from the electrical system of the wind power plant.

The arrangement according to the invention will enable for each of the frequency converters to be brought online/offline individually, meaning that each frequency converter can be connected/disconnected to the generator independently of other cabinets in the system. Preferably each frequency converter of an electrical system according to the invention is dimensioned to a lower power supply compared to a conventional converter, which means that the total plurality of converters according to the invention equals the dimension of one large conventional converter. This arrangement brings several advantages, whereof the most beneficial are the following:
in case of breakdown of one frequency converter, the remaining frequency converters will still enable for partial/complete power withdrawal from the wind turbine;
each frequency converter may undergo maintenance without having to arrest the turbine itself;
the number of frequency converters that are brought online may be adapted to the generated power from the wind turbine meaning each frequency converter will operate close to its optimal efficiency and no-load losses are minimised;
the usage of each frequency converter may be shifted in such a way that they will receive a substantial similar utilization, which will increase the lifetime of each unit compared to a constant use; and
the usage of the frequency converters may be alternated in order to avoid constantly elevated temperatures within the units.

It is to be understood that “utilization” refers to the percentage of time that a unit is in operation, e.g. connected to the electrical system.

Various embodiments of an arrangement will hereinafter be described in more detail with reference to the appended figures. The following description should be considered as preferred form only, and is not decisive in a limiting sense.

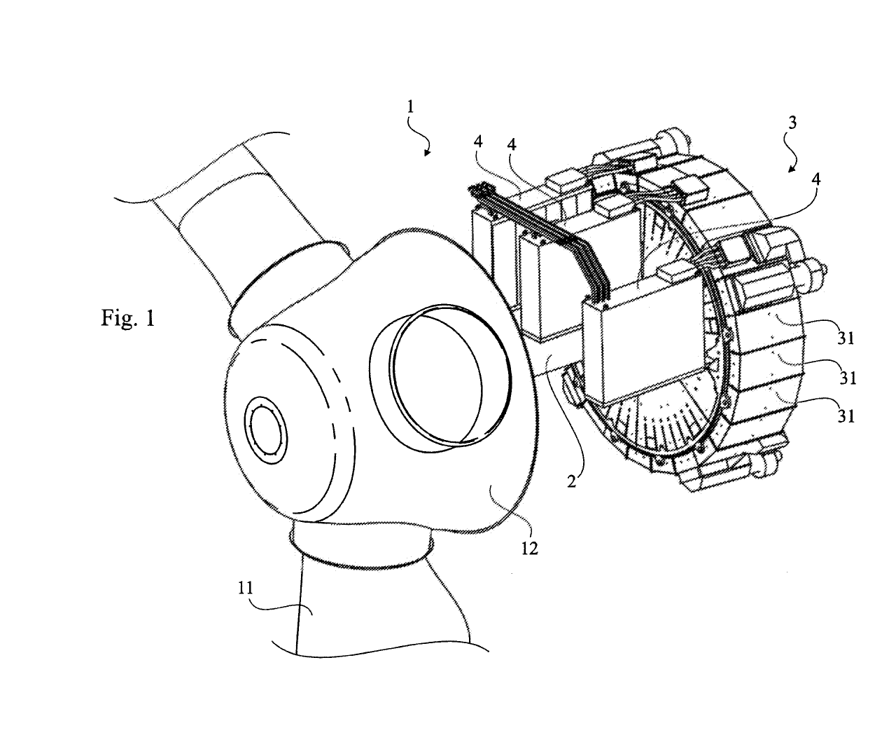

FIG. 1 is a perspective view of a wind power plant comprising a set of three frequency converters,

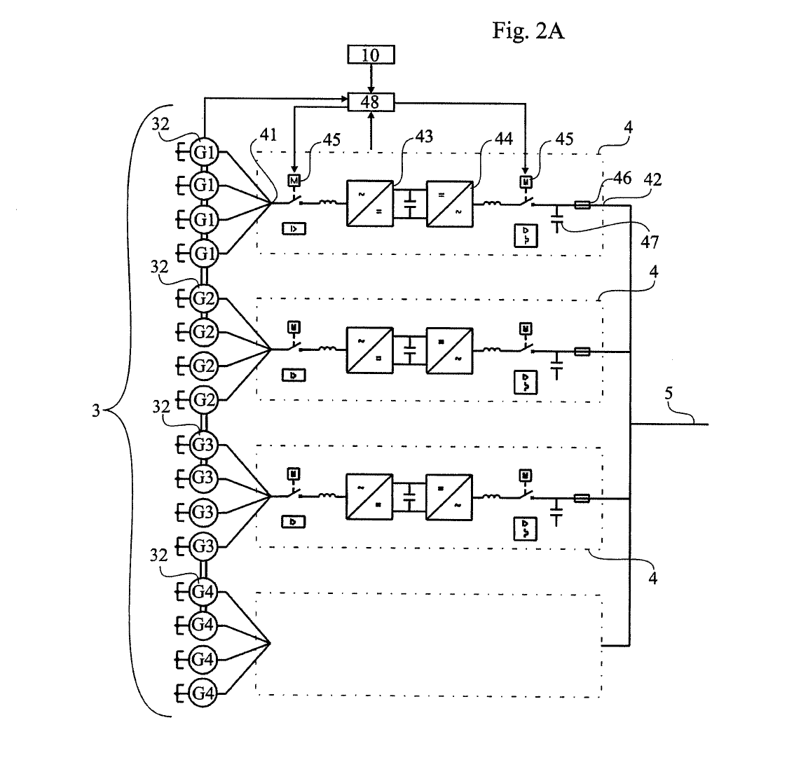

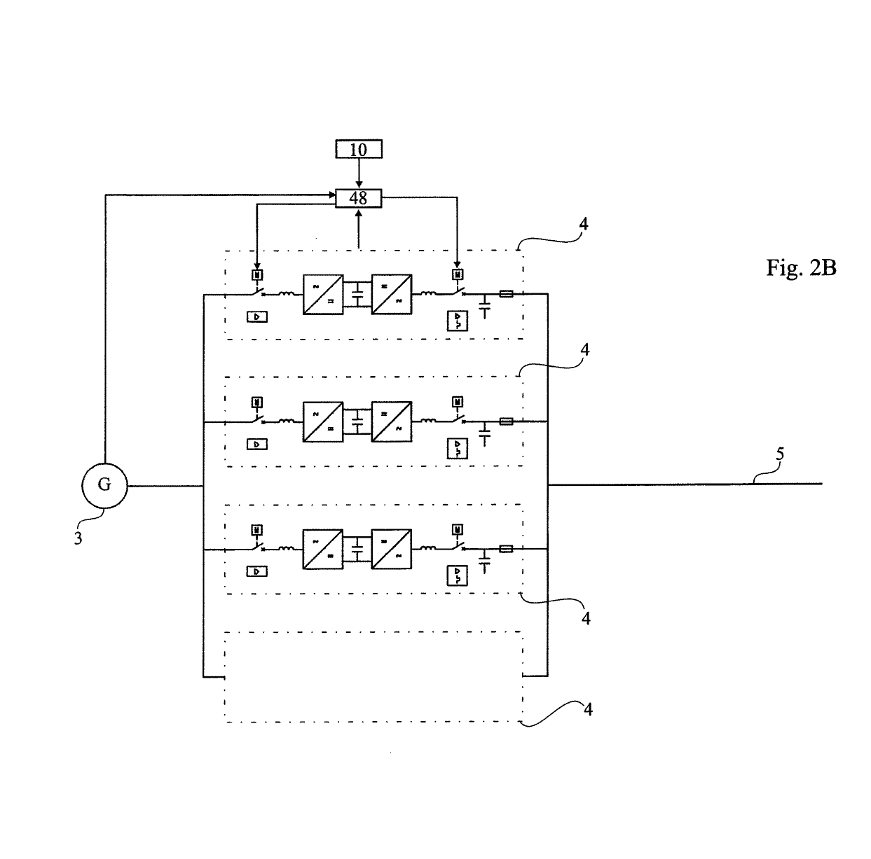

FIG. 2A-2B show detailed diagrams of examples of the frequency converter system; and

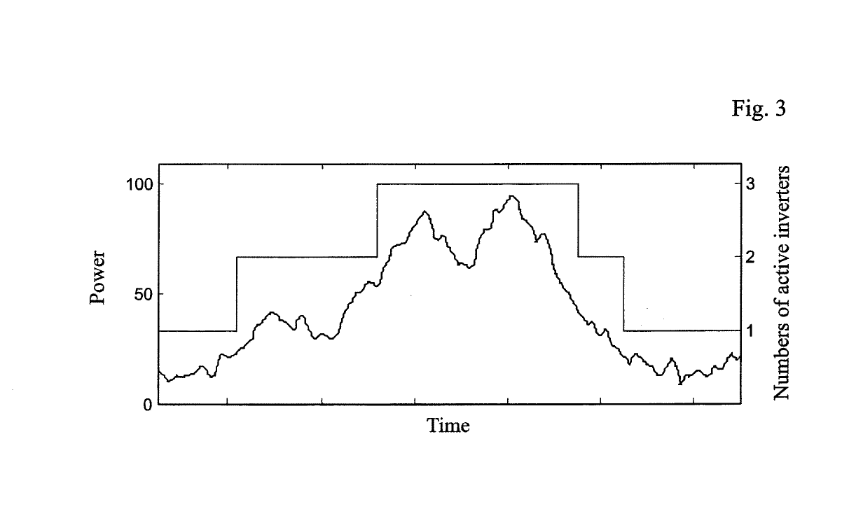

FIG. 3 is a graph showing an example of the relation between the power supply and required number of active frequency converters in the case the maximal number of converters is three.

In FIG. 1 is shown a perspective view of an example of components inside a nacelle cover of a wind power plant 1, comprising rotor blades 11 connected to a hub 12 which, in its turn, connects to a turbine shaft 2 that extends into a generator 3. It is understood that FIG. 1 is showing only the components that are crucial for various embodiments of the present invention and that a wind power plant normally includes various additional components.

Upon rotation of the rotor blades 11 the turbine shaft 2 will transmit the movement into the generator 3 which thus generates AC electrical power. In the given example the wind power plant is designed with a direct driven generator 3, meaning that the main shaft 2 is coupled directly to the generator 3.

As is shown in FIG. 1 the generator 3 is connected to a set of frequency converters 4 (also referred to as “cabinets”) which are connected in parallel to each other. In the given example the number of cabinets 4 is three, but it is understood that a larger number of cabinets may be equally used.

The frequency of an AC electrical power generated within the generator 3 will depend on the rotational speed of the rotor blades 11. The frequency converters 4 will synchronize the AC electrical power from the wind turbine with the AC electrical power within the power grid, which normally is 50 Hz or 60 Hz. By connecting the cabinets 4 in parallel it is possible to independently disconnect any of the units 4 and still retain electrical power from the generator 3, which is further supplied to the power grid. If the wind turbine is operating at a full power rating all of the cabinets 3 will be activated each having a 100% working load. If, for instance, one of the three cabinets 4 will break it is still possible to retain ⅔ of the power that is generated by the wind turbine since two out of three cabinets are still functioning properly.

As is shown in FIG. 1 the generator 3 consists out of a number of cover plates 31 that are arranged next to each other around a circumference of the generator 3. In the given example the generator 3 consists out of a number of smaller generator segments (not shown) that are covered by the cover plates 31. Preferably three cover plates 31 protect one generator segment. It is understood that the use of generator segments represents an example only, and that the generator 3 may consist of a single stator or a series of multiple generators. However, combining multiple, small generator segments is less expensive compared to constructing one large generator, particularly when designing large turbines.

The function of the system will now be described. The wind power plant 1 is put into operational mode whereby the wind will cause the rotor blades 11 and the hub 12 to rotate thus converting fluid-flow power into mechanical power. The turbine shaft 2, which is connected to the hub 12 and extends into the generator 3, will rotate leading to generation of an AC electrical power. The frequency of the generated AC electrical power will vary depending on the strength of the wind. The generator 3 is connected to the plurality of frequency converters 4 which, in their turn, are connected in parallel and are preferably placed adjacent to the generator 3 inside the nacelle of the wind power plant 1. Each converter comprises a rectifier 43 connected in series to an inverter 44, and directing the current through such a unit will lead to a synchronization of incoming frequency with the frequency in the power grid 5. That is, regardless of the power supplied by the wind, the electrical power that leaves a wind power plant 1 will always harmonize with the frequency and voltage within the large power grid 5 thanks to the frequency converters.

The system further comprises a control means, preferably in the form of a turbine control unit (TCU) 48 (shown in FIGS. 2A and 2B), for continuously collecting various data from the wind power plant 1. The collected data is in the form of amount of power generated in the generator 3, whether each cabinet 4 functions properly and also the temperature as well as utilization of each cabinet 4 that is part of the wind power plant 1 system. Preferably the wind turbine 1 also comprises an external control unit 10 which continuously registers the current wind speed and forwards the data to the TCU 48. The external control unit 10 may equally give input to the TCU 48 in the form of expected wind speed.

The control means in the form of the turbine control unit, TCU, 48 may for instance be in the form of a computer based unit, comprising a microprocessor, which receives and processes the input data and further uses the processed data to control the units that are part of the system. However, it is to be understood that any kind of control unit with a corresponding function may equally be used.

The transfer of the data between the TCU 48, the external control unit 10, the generator 3, and a frequency converters 4, is illustrated in FIGS. 2A and 2B with arrows directed between the TCU and respective units. It is understood that the TCU 48 is communicating with each of the frequency converters 4 that are part of the system, although in FIGS. 2A and 2B only communication with one frequency converter 4 is illustrated.

The TCU 48 will comprise means for sequentially activating and deactivating the respective cabinets 4 so that the total number of activated units will be adapted to input power level, or for that matter the registered wind speed. For instance at low registered power levels, or at low registered winds, one cabinet is activated by the TCU 48 and at high power outputs/strong winds all cabinets are activated by the TCU 48. This means that the number of active frequency converters 4 at a certain point may be varied depending on level of incoming power leading/registered wind speed to that the system efficiency is improved even at low powers/low winds. The activation and deactivation of cabinets is enabled by that the TCU 48 controls switching devices 45 within each frequency converter 4. By switching on and off the switching device 45 the TCU 48 is able to connect/disconnect each cabinet 4 respectively. This way the TCU 48 may automatically alternate the use of each of the frequency converters 4 so that no unit will risk to get over heated, and each unit will receive a substantially similar utilization over time. The TCU 48 also registers, in a continuous manner, whether each of the frequency converters 4 that is part of the wind power plant system functions properly, meaning they are not malfunctioning. If any disturbances within any of the frequency converters 4 are discovered, or if complete failure of a cabinet 4 occurs, this unit is instantly disconnected by the TCU 48 by that the TCU 48 signals to the switching device 45 to disconnect the cabinet 4 from the electrical system. In case the wind power plant system is not at a maximum load, a broken cabinet 4 may be replaced by a well functioning one which is put into operation. If the wind power plant system would be at a maximum load, it is still possible to withdraw partial power from the wind turbine; e.g. if one out of three converters breaks when the system is at a maximum load, ⅔ of the power may still be retained by the two remaining functioning cabinets 4.

FIG. 2A-B show detailed diagrams of the frequency converter system with a generator 3 coupled to a set of three frequency converters/cabinets 4 of conventional type connected in parallel with respect to each other. For illustrating purposes an empty space is drawn in FIGS. 2A and 2B representing the possibility of connecting a fourth cabinet 4′ to the wind power plant system. The frequency converters are further connected to a power grid 5. The generator 3, the plurality of frequency converters 4 connected in parallel and the power grid 5 that are shown in the detailed diagram of FIGS. 2A and 2B may be referred to as an electrical system.

Each frequency converter 4 comprises a generator side 41 and a power grid side 42 wherein the generator side constitutes a rectifier 43 and the power grid side constitutes an inverter 44. The rectifier 43 and the inverter 44 of a common cabinet 4 are connected in series. As shown in the diagrams of 2A and 2B each of the generator side 41 and the power grid side 42 respectively comprises a power switch 45 whereby disconnection of the frequency converter from the electrical system is enabled. Each switch 45 of each cabinet 4 is controlled by the TCU 48. If e.g. the registered temperature of a cabinet 4 is above a predetermined limit, the TCU 48 sends a signal to the switch 45 in that cabinet 4 thus disconnecting the cabinet 4. In the case the load on the system is not maximised, the disconnected cabinet 4 can be replaced by another cabinet 4 that may be brought online by that the TCU 48 turns on the corresponding switch 45. This way of altering the utilization of the frequency converters 4 within a wind power plant system will provide a way of avoiding elevated temperatures therein. In the same manner the TCU 48 will alter the use of each cabinet 4 based on their gathered total operating time, thus ensuring that the utilization of each cabinet 4 within a system will be substantially the same.

Furthermore, the power grid side 42 includes resistor unit 46 and a capacitor unit 47 which together will ensure a stable power outflow from the corresponding frequency converter 4.

As is seen in FIG. 2A each frequency converter 4 is connected to a number of generator segments 32 (in this example four segments 32) belonging to one common generator 3. It is understood that each segment 32 in the figure might equally represent one generator.

In FIG. 2B is shown a diagram showing an example of a frequency converter system according to the invention where one large generator 3 is connected to a combined set of frequency converters 4.

FIG. 3 is a graph showing an example of the relation between the power supply and required number of active frequency converters in the case the system comprises three converters 4. The left vertical axis represents the power, the right vertical axis represents number of active frequency converters 4 and the horizontal axis represents time. As is exemplified in the graph of FIG. 3 at low power levels the system will function with one active cabinet 4 whereas an increased power will eventually lead to activation of a second cabinet 4. When the power supply from the wind turbine approaches a maximum level a third cabinet 4 will be brought online, meaning all cabinets are in operation. Activation and deactivation of the respective frequency converters 4 are controlled by the turbine control unit (TCU) 48 which registers input about the power generated in the generator 3 and converts the registered input into signals which controls the switching devices 45 in the cabinets 4 to switch on and off respectively. Accordingly the TCU 48 may receive input about external wind speed as a complement to, or instead of, input about generated power.

Preferably the activation of additional cabinets 4 will occur in such a way before a maximum load of the already activated units is reached so that the system will not be accidentally overloaded.

It is to be noted that the arrangement suggested above can be varied within the scope of the claims and that the method can differ slightly between different embodiments of the invention. Further, the invention is not to be seen as limited by the embodiments described above, but can be varied within the scope of the appended claims.

1.-11. (canceled)

12. A method of generating electric power including the use of a wind power plant which wind power plant comprises a rotatably turbine shaft which extends into a generator which generator is connected to a power grid, the wind power plant further comprising a plurality of frequency converters for converting the frequency of AC electrical power generated by the generator to the frequency of the power grid, which plurality of frequency converters are electrically connected in parallel in between the generator and the power grid, characterized by the steps of:
continuously registering: a) the amount of power generated in the generator, b) an external wind speed, c) whether each of the frequency converters functions properly, d) the temperature in each frequency converter, and e) the utilization of each frequency converter respectively, and,
automatically alternating the use of each of the frequency converters at low registered power and/or at low registered wind speed.

13. A method according to claim 12, further comprising automatically disconnecting any dysfunctional frequency converter from the generator and, if available, replacing it with a properly functioning frequency converter from the plurality thereof.

14. A method according to claim 12, further comprising automatically connecting each of the frequency converters sequentially in case of increasing registered power and/or increasing wind speed to improve system efficiency.

15. A method according to claim 12, further comprising a step of, depending on the registered temperature and utilization respectively, automatically alternating the order in which the frequency converters are brought online.

16. An electric power generating device comprising a wind power plant with a rotatably turbine shaft, a generator connected to a power grid, means for rotating the turbine shaft within the generator thus generating AC electrical power, a plurality of frequency converters for converting the frequency of the AC electrical power to the frequency of the power grid, wherein the plurality of frequency converts are electrically connected in parallel in between the generator and the power grid characterized in that the power generating device further comprises a control unit configured to register external data such as wind speed, a turbine control unit configured to register the amount of power generated in the generator and data in the form of the temperature and utilization of each frequency converter respectively, the turbine control unit using the registered data for automatically alternating the use of each of the frequency converters at low registered power and/or at low registered wind speed.

17. An electric power generating device according to claim 16, wherein the turbine control unit preferably disconnects any dysfunctional frequency converter and, if available, connects a properly functioning frequency converter from the plurality thereof, automatically alternates the use of each frequency converter and/or brings each of the frequency converters online sequentially and/or automatically alternates the order in which the frequency converters are brought online.

18. An electric power generating device according to claim 16, wherein the turbine control unit is provided for bringing each of the frequency converters online/offline individually and independently of other frequency converters within the system.

19. An electric power generating device according to claim 16, wherein the number of frequency converters equals at least two, preferably at least three.

20. An electric power generating device according to claim 16, wherein the turbine control unit is communicating with switching devices in each of the frequency converters that is part of the power generating device.

21. An electric power generating device according to claim 16, wherein the control unit configured to register external data is communicating with the turbine control unit.

22. An electric power generating device according to claim 16, wherein the generator consists out of a number of connected generator segments.
